(19) United States
(12) Patent Application Publication
(10) Pub. No.: US 2023/0316744 A1
(43) Pub. Date: Oct. 5, 2023

(54) METHOD AND SYSTEM FOR REMOTELY ANALYSING TREES

(71) Applicant: Sharper Shape Oy, Espoo (FI)

(72) Inventors: Jaro Uljanovs, Espoo (FI); Rami Piiroinen, Espoo (FI); Anand Umashankar, Espoo (FI)

(73) Assignee: Sharper Shape Oy, Espoo (FI)

(21) Appl. No.: 17/710,023

(22) Filed: Mar. 31, 2022

(51) Int. Cl. G06V 20/10; G01S 17/89; G06T 7/62

(52) U.S. Cl. CPC G06V 20/188; G01S 17/89; G06T 7/62; G06T 2207/20084; G06T 2207/10036; G06T 2207/30188; G06T 2207/20081; G06V 20/194

(57) ABSTRACT

A method for remotely analysing trees present in environment, including: obtaining LiDAR dataset of environment; detecting tree(s) represented in LiDAR dataset using pre-trained graph neural network, wherein tree(s) is assigned unique identifier upon detection; identifying trunk of tree(s) using statistical technique(s); determining directional vector of trunk of tree(s) using linear fitting technique(s); determining diameter of trunk of tree(s) at predetermined height from highest point of ground surface surrounding trunk, wherein directional vector is employed for determining diameter of the trunk; and predicting age of tree(s), based at least on diameter of trunk.

### TECHNICAL FIELD

The present disclosure relates to methods for remotely analysing trees present in environments. Moreover, the present disclosure also relates to systems for remotely analysing trees present in environments.

### BACKGROUND

With growing technology and population, dependability on technology has also grown. From electricity to internet, humans constantly need connectivity with the rest of the world. In such day and age, it is highly problematic when there are system failures in power distribution systems. Although using protective outer casings and building high poles assists in protecting such systems, they are not always safe since a lot of power distribution channels pass through forest area, and trees fall on them (especially during bad weather), causing damage. While ensuring a constant supply of electricity is necessary, protecting the environment is also important. Typically, older trees are more susceptible to fall and damage the power distribution systems. In some cases, this may happen due to age; but in other cases, trees collapse due to age as well as bad weather conditions.

An accurate analysis of an age of a tree is essential in order to determine whether or not said tree will fall and cause damage. A tree's age is accurately calculated by counting a number of rings forming within the trunk. This can be achieved in two ways. Firstly, by chopping the tree off, and secondly, by drilling holes in the trunk of the tree using an increment borer. When the increment borer is used, it extracts cylindrical pieces of wood (for example, having a thickness of a pencil), such that the number of rings may be counted on the same for estimating the age of the tree.

However, both these methods are invasive and damage the structural integrity of the tree. This irreparably damages the environment and increases costs as well since trained arborists are required to perform certain methods.

Therefore, in light of the foregoing discussion, there exists a need to overcome the aforementioned drawbacks associated with existing techniques for analysing trees.

### SUMMARY

The present disclosure seeks to provide a method for remotely analysing trees present in an environment. The present disclosure also seeks to provide a system for remotely analysing trees present in an environment. An aim of the present disclosure is to provide a solution that overcomes at least partially the problems encountered in prior art.

In one aspect, an embodiment of the present disclosure provides a method for remotely analysing trees present in an environment, the method comprising:
obtaining a Light Detection and Ranging (LiDAR) dataset of the environment;
detecting at least one tree represented in the LiDAR dataset using a pre-trained graph neural network, wherein the at least one tree is assigned a unique identifier upon detection;
identifying a trunk of the at least one tree using at least one statistical technique;
determining a directional vector of the trunk of the at least one tree using at least one linear fitting technique;
determining a diameter of the trunk of the at least one tree at a predetermined height from a highest point of a ground surface surrounding the trunk, wherein the directional vector is employed for determining the diameter of the trunk; and
predicting an age of the at least one tree, based at least on the diameter of the trunk.

In another aspect, an embodiment of the present disclosure provides a system for remotely analysing trees in an environment, the system comprising at least one processor, wherein the at least one processor is configured to:
obtain a Light Detection and Ranging (LiDAR) dataset of the environment;
detect at least one tree represented in the LiDAR dataset using a pre-trained graph neural network, wherein the at least one tree is assigned a unique identifier upon detection;
identify a trunk of the at least one tree using at least one statistical technique;
determine a directional vector of the trunk of the at least one tree using at least one linear fitting technique;
determine a diameter of the trunk of the at least one tree at a predetermined height from a highest point of a ground surface surrounding the trunk, wherein the directional vector is employed for determining the diameter of the trunk; and
predict an age of the at least one tree, based at least on the diameter of the trunk.

Embodiments of the present disclosure substantially eliminate or at least partially address the aforementioned problems in the prior art, and enable remote analysis of trees in the environment.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 illustrates steps of a method for remotely analysing trees present in an environment, in accordance with an embodiment of the present disclosure;

FIG. 2 illustrates a step of detection of at least one tree represented in the LiDAR dataset, in accordance with an embodiment of the present disclosure;

FIG. 3 illustrates a step of identification of a trunk of at least one tree, in accordance with an embodiment of the present disclosure;

FIG. 4 illustrates a step of determination of a diameter of a trunk of at least one tree, in accordance with an embodiment of the present disclosure; and

FIG. 5 is a schematic illustration of a system for remotely analysing trees present in an environment, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a method for remotely analysing trees present in an environment, the method comprising:
obtaining a Light Detection and Ranging (LiDAR) dataset of the environment;
detecting at least one tree represented in the LiDAR dataset using a pre-trained graph neural network, wherein the at least one tree is assigned a unique identifier upon detection;
identifying a trunk of the at least one tree using at least one statistical technique;
determining a directional vector of the trunk of the at least one tree using at least one linear fitting technique;
determining a diameter of the trunk of the at least one tree at a predetermined height from a highest point of a ground surface surrounding the trunk, wherein the directional vector is employed for determining the diameter of the trunk; and
predicting an age of the at least one tree, based at least on the diameter of the trunk.

In another aspect, an embodiment of the present disclosure provides a system for remotely analysing trees in an environment, the system comprising at least one processor, wherein the at least one processor is configured to:
obtain a Light Detection and Ranging (LiDAR) dataset of the environment;
detect at least one tree represented in the LiDAR dataset using a pre-trained graph neural network, wherein the at least one tree is assigned a unique identifier upon detection;
identify a trunk of the at least one tree using at least one statistical technique;
determine a directional vector of the trunk of the at least one tree using at least one linear fitting technique;
determine a diameter of the trunk of the at least one tree at a predetermined height from a highest point of a ground surface surrounding the trunk, wherein the directional vector is employed for determining the diameter of the trunk; and
predict an age of the at least one tree, based at least on the diameter of the trunk.

The present disclosure provides the aforementioned method and the aforementioned system for remotely analysing trees present in an environment. Herein, the LiDAR dataset of the environment is obtained and at least one tree is detected therein using the pre-trained graph neural network. Such remote detection of trees is time-saving and cost-efficient. The method is well-suited for object detection as the LiDAR dataset is captured from a relatively low altitude. This facilitates in obtaining highly accurate and dense point clouds that include considerable data available per tree. Moreover, the at least one tree is assigned the unique identifier which captures the region, location and species of the at least one tree. This assists in having a labelled dataset which does not need to be constantly updated (i.e., only new trees have to be updated every few years). Thereon, the trunk of the at least one tree is identified, and the directional vector is determined for the same. Determining the directional vector assists in remotely determining the diameter. This saves costs as well since manual intervention is not required on-site. Moreover, the diameter of the trunk is determined, which thereon assists in predicting the age of the at least one tree. This method is non-invasive and does not unnecessarily harm the environment, while also ensuring safety to power distribution systems. Indeed analysing trees present in an environment thus can be considered to comprise prediction of the age of the at least one tree. The age of the tree is important to identify which trees should be for example cut down and which not to cut down. Furthermore in one additional or alternative embodiment the species of at least one tree can be used as part of the analysis. Certain species have longer life time than others thus age and tree species can be together used for analysis in some embodiment.

Throughout the present disclosure, the term “LiDAR dataset” refers to a collection of data captured by a LiDAR system. Optionally, the LiDAR system (for example, such as a LiDAR laser scanner) is embedded on an unmanned aerial vehicle that is employed for capturing a given LiDAR dataset of the environment. Optionally, a given unmanned aerial vehicle is implemented as a drone, a helicopter, and the like. Optionally, the given LiDAR dataset comprises a plurality of LiDAR data points. Optionally, when the given unmanned aerial vehicle is implemented as the helicopter, a large volume of LiDAR data points are generated in the given LiDAR dataset. The plurality of LiDAR data points represent objects (such as, buildings, vegetation, and the like) on and above a ground surface in a three-dimensional space of the environment. Optionally, location of a LiDAR given data point is expressed as (x, y, z) coordinates along X, Y, and Z axes, respectively of a given coordinate system employed for the environment. Optionally, the plurality of LiDAR data points are collectively referred to as point clouds. It will be appreciated that the method enables remote analysis of the trees since the LiDAR dataset is captured using the given unmanned aerial vehicle.

The term “graph neural network” refers to a network which identifies patterns and relations in a given graph-based dataset. Optionally, graph neural networks are utilised to identify patterns and relations in three-dimensional datasets. Examples of graph neural networks include, but are not limited to, a Recurrent Graph Neural Network (R-GNN), a Spatial Convolutional Network, and a Spectral Convolutional Network.

Optionally, the pre-training of the graph neural network is done by:
obtaining a reference LiDAR dataset of the environment;
dividing the reference LiDAR dataset into a plurality of tiles;
annotating a set of tiles from amongst the plurality of tiles to enable identification of at least one tree represented in the set of tiles; and
training the graph neural network using at least one machine learning algorithm, wherein the graph neural network is trained to identify the at least one tree.

The term “reference LiDAR dataset” refers to a LiDAR dataset which is used as a reference to train the graph neural network. Since LiDAR datasets comprise large volumes of information, a given LiDAR dataset is divided into the plurality of tiles, such that each tile may be appropriately processed to identify the at least one tree. Optionally, representations of a predetermined number of trees are identified in a tile from the set of tiles. Optionally, the set of tiles are annotated using at least one image annotation technique. Optionally, the reference LiDAR dataset is annotated to be a labelled dataset. More optionally, the reference LiDAR dataset is annotated to be representative of at least one of: a region, a date, a distance from a power distribution infrastructure. Optionally, the reference LiDAR dataset is annotated manually. It will be appreciated that the reference LiDAR dataset is annotated for accurately training the graph neural network to identify the at least one tree.

The term “machine learning algorithm” refers to an algorithm which converts the given LiDAR dataset into a model to easily identify patterns. Examples of machine learning algorithms include, but are not limited to, an object detection algorithm, a decision trees algorithm, a Naïve Bayes algorithm, a K-Nearest Neighbors (KNN) algorithm, a Learning Vector Quantization (LVQ) algorithm, and a Random Forests algorithm. Optionally, the at least one machine learning algorithm is implemented as the object detection algorithm. More optionally, the at least one machine learning algorithm is implemented as a bounding box algorithm. Herein, the at least one machine learning algorithm identifies the at least one tree and bounds a representation of the at least one tree in the given LiDAR dataset with a box for ease of recognition. A technical benefit of pre-training the graph neural network is that it gives the graph neural network to LiDAR datasets of the environment, which refines the graph neural network, increasing efficiency and reducing errors. Another technical benefit of pre-training the graph neural network is that it makes the graph neural network faster and more reliable as compared to when the graph neural network is not trained. Yet another technical benefit is that such a pre-training saves energy.

The term “unique identifier” refers to an identifier which is unique for a given tree among all identifiers assigned to the trees in the environment. The unique identifier may be a sequence of numerals, alphabets and/or special characters utilised to identify the given tree. Optionally, the unique identifier is assigned based on at least one of: a geographical area of the given tree, a sequence of assignment of the given tree, a species of the given tree, a predicted age of the given tree.

Optionally, the pre-trained graph neural network is further used to provide a detection probability signal, and if a detection probability is less than a predefined threshold, the method further comprises initiating a re-measurement for updating the LiDAR dataset of the environment. Herein, the detection probability signal refers to a signal which identifies a probability of detection. This is done by calculating a ratio of number of trees detected and a plurality of additional objects present in the environment. Optionally, the detection probability is implemented as at least one of: a percentage, a number from a range of numbers. In an example, the detection probability may be 30%. In another example, the detection probability may be 6 on a range of 10. Optionally, the predefined threshold lies in a range of 60-80 percent. In an example, if the detection probability is 55% and the predefined threshold is 65%, the re-measurement would be required. In another example, if the detection probability is 80% and the predefined threshold is 70%, the re-measurement would be not required. Optionally, the detection probability signals and detected trees thereof are updated in the LiDAR dataset. A technical benefit of providing the detection probability signal is to identify at least one of: a region where the detection probability signal is high, a speed at which the detection probability signal is high; in order to ensure appropriate high-quality capture of LiDAR datasets. Optionally, the re-measurement is implemented using the unmanned aerial vehicle.

Optionally, the re-measurement is implemented by using modified parameters. The modified parameters refer to a modification of at least one parameter, in order to achieve improved results. Optionally, the parameters are implemented as at least of: a given region in the environment, a speed of the unmanned aerial vehicle, a route of the unmanned aerial vehicle, an angle of the unmanned aerial vehicle, a view from the unmanned aerial vehicle. Optionally, the method further comprises modifying a given parameter. Optionally, the unmanned aerial vehicle is manually signalled to modify the parameters. A technical advantage of re-measuring using modified parameters is that the training of the graph neural network is more efficient and time-saving. Another technical advantage is that since training is more efficient, shorter flights are required from the unmanned aerial vehicle, resulting in a lesser amount of required data and energy saving.

Optionally, the trunk of the at least one tree is identified by differentiating the trunk from at least one of: a branch of the at least one tree, a leaf of the at least one tree, a canopy of the at least one tree. Herein, the term “statistical technique” refers to a mathematical formula, model, or technique which is used to statistically analyse the LiDAR dataset. Examples of the at least one statistical technique include, but are not limited to, a principal component analysis (PCA) technique, a connectivity analysis technique, a non-negative matrix factorization (NMF) technique, a kernel a principal component analysis technique, a graph-based kernel a principal component analysis technique, a linear discriminant analysis (LDA) technique, and a generalized discriminant analysis (GDA). Optionally, the at least one statistical technique is implemented using at least a tree segregation (i.e., treeseg) algorithm.

Moreover, the directional vector of the trunk refers to a straight vertical line which runs through the trunk of the at least one tree. The term “linear fitting algorithm” refers to an algorithm which constructs a straight line having a best fit to a series of LiDAR data points. For example, if there are 5 given LiDAR data points in a slight curve, the directional vector may be a straight line constructed between a first LiDAR data point and a fifth LiDAR data point by the at least one linear fitting algorithm, since a curvature is not accounted for. Examples of the at least one linear fitting technique include, but are not limited to, an ordinary least squares (OLS) technique, a simple linear regression technique, a robust simple linear regression technique, a linear least squares technique, and a linear segmented regression technique.

The term “predefined height” refers to a standardised height at which the diameter of the trunk is accurately determined. Optionally, the predetermined height lies in a range of 100 cm to 170 cm. For example, the predetermined height may be from 100, 110, 130, 150 or 160 cm up to 105, 110, 120, 135, 150 or 170 cm. In an example, the predetermined height mat be 135 cm. Notably, a diameter of the trunk may differ at different heights. It will be appreciated that the diameter of the trunk is determined at the predefined height, since such determination of the diameter accurately predicts the age of the at least one tree.

Optionally, the step of determining the diameter of the trunk comprises:
capturing LiDAR data points in a z-dimension at the predetermined height in a vicinity of the at least one tree, wherein the z-dimension is parallel to the directional vector of the trunk of the at least one tree;
performing a coordinate transformation of the LiDAR data points so that the LiDAR data points are indicated in a two-dimensional plane that is representative of a two-dimensional cross-section of the trunk;
determining a radius of the trunk using the two-dimensional cross-section by employing a circle fitting technique; and
calculating the diameter of the trunk by doubling the radius of the trunk.

Since the directional vector is a vertical line, being perpendicular to the ground surface, and the z-dimension is parallel to the directional vector, the z-dimension is also vertical and is perpendicular to the ground surface. Optionally, the LiDAR data points are captured within a parameterized buffer of the predetermined height. Optionally, the parameterized buffer lies in a range of 20 cm to 60 cm. For example, the parameterized buffer may be from 20, 25, 30, 40, or 50 cm up to 25, 30, 35, 45 or 60 cm. In an example, the parameterized buffer may be 40 cm. It will be appreciated that the parameterized buffer enables capture of a large amount of LiDAR data points, which results in improved accuracy.

The term “coordinate transformation” refers to transforming or modifying coordinates of the LiDAR data points. Herein, the coordinates of the LiDAR data points are transformed to be in the same plane. This is performed by selecting a standard z-coordinate value (for example, 1.35 m), for the LiDAR data points, resulting in a two-dimensional representation of a cross-section of the trunk. The circle fitting technique refers to a technique which fits a smallest possible circle using the LiDAR data points. Optionally, at least three LiDAR data points are required to fit the smallest possible circle. Optionally, the circle fitting technique is implemented by minimising a least squares error of an equation of a circle.

This is mathematically represented as:

F(k,m,r)=Σ[(xᵢ−k)²+(yᵢ−m)²−(r²)²];
wherein:
(xi, yi) are coordinates of a given LiDAR data point (at a circumference),
(k, m) are coordinates of a centre of the circle, and
r is the radius of the circle.

Optionally, the age of the at least one tree is predicted by employing predictive modelling. Predictive modelling may be implemented by at least using one of: a graph neural network, a convolutional neural network, a capsule neural network. A technical advantage of employing predictive modelling is this that it utilises spatial topological changes as well as spectral signature changes of the at least one tree for training the graph neural network. Beneficially, employing such predictive modelling yields better results during inference, as compared to when predictive modelling is not employed. It will be appreciated that the age of the at least one tree is accurately predicted, depending on the diameter of the trunk. For example, for a given tree which observes growth in the diameter of the trunk from 1-100 centimetres through a life of 100 years, if the diameter for the given tree measures 23 cm, the age of the given tree may be predicted to be 20 years. Moreover, species and diameter of a given tree are mapped using arborists datasheets to determine an approximate age of the given tree. Such arborist datasheets are empirical tables that provide information pertaining to growth of trees. It will be appreciated that since growth of trees varies from region to region (based on weather conditions, fertility of soil, and so forth), the arborist datasheets vary for different regions as well. Beneficially, the method timely identifies old trees having a risk (i.e., risky trees) of falling and causing damage, and takes appropriate action.

Optionally, the method further comprises:
obtaining species information pertaining to the at least one tree, wherein the species information depends on at least one of: an average growth rate in the environment, hyperspectral data of the environment;
obtaining a location information of the at least one tree by at least one of: manual surveying of the environment, satellite surveying of the environment, receiving geolocation data from a geolocation device attached to the at least one tree, accessing from a memory having the location information;
determining a growth factor of the at least one tree, based on the species information and the location information; and
predicting the age of the at least one tree, based also on the growth factor.

Optionally, the species of the at least one tree are detected based on the average growth rate in the environment. It will be appreciated that the average growth rate in the environment depends on type of species of the at least one tree present in the environment and growth rate of individual species. Some species of trees (such as, eucalyptus) may have a higher growth rate, while other species of trees (such as, white cedar) may have a lower growth rate. It will be appreciated that the average growth rate in the environment may also vary according to soil, rainfall, temperature, humidity, and the like, in the environment. Optionally, growth rate for a given species of tree is predefined.

Additionally or alternatively, optionally, the species of the at least one tree are detected based on the hyperspectral data of the environment. Herein, the term “hyperspectral data” refers to information of electromagnetic spectrum for each pixel in a hyperspectral image of the environment. Optionally, the hyperspectral image is captured by a hyperspectral camera that is arranged on an unmanned aerial vehicle. Optionally, the hyperspectral image comprises spatial information (namely, image features) and spectral information (namely, spectral-bands) of the environment. Different species of trees reflect different amount of radiation in different regions of the electromagnetic spectrum. Optionally, detecting the species of the at least one tree comprises: determining spectral signatures of each pixel representing the at least one tree, in hyperspectral data of the environment; and analysing the spectral signatures to classify the at least one tree into one or more species.

In an embodiment, the species information is pre-generated by an external processor and is pre-stored at a data repository. In such a case, the species information is accessed from the data repository. In another embodiment, the species information is generated by processing the average growth rate in the environment, the hyperspectral data of the environment.

The location information refers to a precise location of a given tree in the environment. Optionally, the location information is expressed in latitudes and longitudes. For example, the location information of the given tree may be a latitude 38.8951 and longitude −77.0364. Optionally, the manual surveying of the environment is performed by at least one of: a manually controlled unmanned aerial vehicle, a person manually assigning location to each tree having a given unique identifier. Optionally, the geolocation data is stored at the data repository. Optionally, the location information is pre-generated and is pre-stored at the data repository. Optionally, the location information is accessible based on the given unique identifier of the given tree.

The term “growth factor” refers to a numeric factor which monitors growth of a given tree. The growth factor is an estimation of growth of the given tree, based on the age of the given tree and the diameter of the trunk of the given tree. Optionally, the growth factor varies for different species. For example, a tree T1 may have a higher growth factor indicating that a species of tree T1 grows to be bigger as compared to a tree T2 having a lower growth factor, which grows to remain comparatively smaller. Optionally, the growth factor varies at different locations. It will be appreciated that a higher growth factor may be observed at fertile locations, as compared to a lower growth factor at barren locations. Optionally, when the detected species of the given tree is known, the growth factor of species of the given tree is also known. In such a case, growth of the given tree in the environment can be predicted based on the growth factor of species of the given tree. It will be appreciated that the age of the tree can be predicted by multiplying the diameter of the trunk of the at least one tree with the growth factor of the at least one tree. Optionally, growth factor for a given species of tree is predefined. Optionally, a given species of trees in the environment are detected when an average growth factor in the environment lies within a predefined threshold of the growth factor for the given species of trees. A technical advantage of predicting the age of the at least one tree using the growth factor is that it is non-invasive (i.e., does not require drilling into the at least one tree and hampering the environment), while still being accurate.

Optionally, the method further comprises:
obtaining information pertaining to a power distribution infrastructure in the environment;
determining, based on the LiDAR dataset, vegetation data of the at least one tree, wherein the vegetation data comprises a height of the at least one tree and a location of the at least one tree within the environment;
determining whether or not a given tree is a risky tree by assessing a risk posed by the given tree, wherein the risk is assessed based at least on: the information pertaining to the power distribution infrastructure, an age of the given tree, the vegetation data; and
generating an alert for removal of the given tree, when the given tree is determined to be a risky tree.

Herein, the term “power distribution infrastructure” refers to utility infrastructure for delivering electric power within and/or through the environment. Optionally, the electric power is delivered via poles and powerlines of the power distribution infrastructure. Optionally, the information pertaining to the power distribution infrastructure comprises at least one of: a digital surface model of the environment, a number of poles in the power distribution infrastructure, types of the poles, heights of the poles, locations of the poles, powerline hanging parameters. Optionally, said information is obtained from the data repository. Optionally, said information is obtained from unmanned aerial vehicles employed for capturing said information. Optionally, in the powerline hanging parameters, thermal expansion of the powerlines is taken into account to ascertain minimum heights of the poles in the power distribution infrastructure. Optionally, the information pertaining to the power distribution infrastructure is employed to plan the flight trajectories of the unmanned aerial vehicles. In this way, the LiDAR system mounted on the unmanned aerial vehicles captures, by way of the LiDAR dataset, the vegetation data that surrounds the power distribution infrastructure.

Herein, the term “vegetation data” refers to information pertaining to the at least one tree within the environment. Optionally, the vegetation data further comprises at least one of: the height of the at least one tree, the location of the at least one tree within the environment, the growth factor of the at least one tree, a standard deviation of the growth factor of the at least one tree. Optionally, the vegetation data for the at least one tree is determined based on the LiDAR dataset of the environment. Technical benefits arising out of utilizing the LiDAR dataset are high accuracy and low processing time in determining the vegetation data for the at least one tree as information pertaining to the at least one tree is already known and accurately known in the updated LiDAR dataset.

Throughout the present disclosure, the term “risky tree” refers to a tree that is likely to fall onto the power distribution infrastructure (such as, the poles and/or the hanging powerlines in the power distribution infrastructure) in proximity of said tree. If any tree falls onto the power distribution infrastructure, it could lead to disruption in delivering electric power and/or could cause fire due to a circuit break. In this regard, it is of critical importance that such risky trees are identified and timely removed or trimmed in order to prevent damage of the power distribution infrastructure. Operation of the power distribution infrastructure is required to be maintained reliably. Optionally, digitally identifying the risky trees enables efficient vegetation management whilst ensuring that operation of the power distribution infrastructure is maintained. This facilitates reduction in cost of vegetation management, better vegetation management planning, and the like. Optionally, the risk is assessed also based on the species of the given tree. Optionally, the vegetation data also comprises species information of the at least one tree. Optionally, the risk is assessed also based on environmental conditions in the environment.

In some instances, the growth factor and location of the given tree may be such that the given tree would never become the risky tree in the future. In an example, locations of some trees may be close to the power distribution infrastructure, but their growth factor may indicate that these trees grow in a manner (for example, extremely slowly) that they would not become risky trees in the future. In another example, locations of some trees may be so far from the power distribution infrastructure that irrespective of their growth indicated by the predictive growth model, these trees would not become risky trees in future.

Optionally, the assessment of risk is represented as a data value wherein, the given tree is determined to be a risky tree when the assessment of risk lies below or is equal to a risk threshold, and the given tree is not determined to be a risky tree when the assessment of risk lies above the risk threshold. Optionally, the alert for removal of the given tree is generated at a device associated with at least one of: a maintenance person, a maintenance robot, wherein the alert pertains to the at least one risky tree to be removed. The alert has information pertaining to a removal of the given tree to be performed. Optionally, the alert comprises at least one of: the unique identifier of at least one tree, the location of at least one tree. A technical advantage of generating the alarm for removal of a risky tree is that the risky tree is trimmed or removed before it damages the environment.

Optionally, the method further comprising:
obtaining species information pertaining to the at least one tree, wherein the species information depends on at least one of: an average growth rate in the environment, hyperspectral data of the environment;
generating a predictive growth model for the at least one tree, based on at least: the species information of the at least one tree, the age of the at least one tree; and
estimating, based on the predictive growth model, vegetation data and information pertaining to the power distribution infrastructure in the environment, a future time instant at which the given tree would become a risky tree, when the given tree is not determined to be a risky tree.

Herein, the term “predictive growth model” refers to a model that predicts growth of the at least one tree. In some implementations, a single predictive growth model is generated to predict growth of the at least one tree, whereas in other implementations individual predictive growth models are generated to predict growth of individual trees. In an example, the predictive growth model may indicate a growth rate of 1 meter per year for the at least one tree. It will be appreciated that geological factors (such as soil, rainfall, temperature, humidity, and the like) can also be used for generating the predictive growth model. Additionally, optionally, when the detected species of the at least one tree is known, growth factor of species of the at least one tree is also known. In such a case, growth of a given tree in the environment can be predicted based growth factor of species of the given tree. Then, the predictive growth model is generated based at least on the growth factor of species of the trees, since the growth factor of species of the trees indicates how the trees belonging to a particular species can grow in future.

Optionally, the future time instant at which the given tree would become the risky tree is determined by: determining a distance between the given tree and the power distribution infrastructure, determining a height of the given tree, determining if the given tree would damage the power distribution infrastructure on falling using the Pythagorean sum, subtracting the height of the given tree from the Pythagorean sum of the distance of the given tree from the power distribution infrastructure and the height of the power distribution infrastructure in the proximity of the given tree; and dividing the difference obtained upon subtracting by the growth rate of the given tree. In an example, the Pythagorean sum may be 10 meters, the height of the given tree at the second time period may be 7 meters, and the growth factor of the given tree by the predictive growth model of the given tree may be 1 meter per year. In such a case, the future time instant at which the given tree would become the risky tree may be 3 years (as (10−7)/1 equals 3) from the second time period.

In some instances, the predictive growth model and location of the given tree may be such that the given tree would never become the risky tree in the future. In an example, locations of some trees may be close to the power distribution infrastructure, but their predictive growth models may indicate that these trees grow in a manner (for example, extremely slowly) that they would not become risky trees in the future. In another example, locations of some trees may be so far from the power distribution infrastructure that irrespective of their growth indicated by the predictive growth model, these trees would not become risky trees in future. A technical advantage of estimating the future time instant at which the given tree would become the risky tree is that if such estimation is already performed, risky or to-be-risky trees can be scheduled to be trimmed or removed before they damage the environment.

Optionally, the method further comprises creating an order of priority for removal of one or more trees that are determined to be risky trees, based on the assessment of risk posed by the one or more trees, wherein one or more alerts are generated for removal of the one or more trees based on the order of priority. Herein, the order of priority refers to the order of removal of risky trees. For example, a first tree having order of priority 1 is to be removed urgently, whereas a second tree having order of priority 37 may be removed after removing risky trees 1-36. Optionally, creation of the order of priority comprises determining a route for risky tree removal, based on the locations of the identified risky trees and/or the locations of trees that are likely to become risky trees in the future. Optionally, creation of the order of priority further comprises estimating which route for the risky tree removal to follow at which time instant. Optionally, in the order of priority, a vegetation management team (for example, such as lumberjacks, vegetation management personnel, and the like) is employed to remove or trim the trees that are identified as the risky trees and/or are likely to become the risky trees. A technical advantage of creating the order of priority for removal of risky trees and generating subsequent alerts is that resources are planned ahead and appropriately utilized to prevent damage to life and property by risky trees falling.

The present disclosure also relates to the system as described above. Various embodiments and variants disclosed above, with respect to the aforementioned first aspect, apply mutatis mutandis to the system.

Optionally, the system further comprises a data repository, wherein the data repository is communicably coupled to the processor. Optionally, the at least one processor is configured to store the LiDAR dataset, the pre-trained graph neural network, the unique identifier of the at least one tree, the diameter of the trunk of the at least one tree, the predetermined height, the age of the at least one tree (i.e., predicted age), and so forth.

Optionally, the at least one processor is further configured to:
obtain species information pertaining to the at least one tree, wherein the species information depends on at least one of: an average growth rate in the environment, hyperspectral data of the environment;
obtain location information of the at least one tree by at least one of: manual surveying of the environment, satellite surveying of the environment, receiving geolocation data from a geolocation device attached to the at least one tree, accessing from a memory having the location information;
determine a growth factor of the at least one tree, based on the species information and the location information; and
predict the age of the at least one tree, based also on the growth factor.

Optionally, the at least one processor is further configured to train the graph neural network, wherein when training the graph neural network, the at least processor is configured to:
obtain a reference LiDAR dataset of the environment;
divide the reference LiDAR dataset into a plurality of tiles;
annotate a set of tiles from amongst the plurality of tiles to enable identification of at least one tree represented in the set of tiles; and
train the graph neural network using at least one machine learning algorithm, wherein the graph neural network is trained to identify the at least one tree.

Optionally, when determining the diameter of the trunk, the at least one processor is further configured to:
capture LiDAR data points in a z-dimension at the predetermined height in a vicinity of the at least one tree, wherein the z-dimension is parallel to the directional vector of the trunk of the at least one tree;
perform a coordinate transformation of the LiDAR data points so that the LiDAR data points are indicated in a two-dimensional plane that is representative of a two-dimensional cross-section of the trunk;
determine a radius of the trunk using the two-dimensional cross-section by employing a circle fitting technique; and
calculate the diameter of the trunk by doubling the radius of the trunk.

Optionally, the at least one processor is further configured to:
obtain information pertaining to a power distribution infrastructure in the environment;
determine, based on the LiDAR dataset, vegetation data of the at least one tree, wherein the vegetation data comprises a height of the at least one tree and a location of the at least one tree within the environment;
determine whether or not a given tree is a risky tree by assessing a risk posed by the given tree, wherein the risk is assessed based at least on: the information pertaining to the power distribution infrastructure, an age of the given tree, the vegetation data; and
generate an alert for removal of the given tree, when the given tree is determined to be a risky tree.

Optionally, the at least one processor is further configured to:
obtain species information pertaining to the at least one tree, wherein the species information depends on at least one of: an average growth rate in the environment, hyperspectral data of the environment;
generate a predictive growth model for the at least one tree, based on at least: the species information of the at least one tree, the age of the at least one tree; and
estimate, based on the predictive growth model, vegetation data and information pertaining to the power distribution infrastructure in the environment, a future time instant at which the given tree would become a risky tree, when the given tree is not determined to be a risky tree.

Optionally, the at least one processor is further configured to create an order of priority for removal of one or more trees that are determined to be risky trees, based on the assessment of risk posed by the one or more trees, wherein one or more alerts are generated for removal of the one or more trees based on the order of priority.

Optionally, the at least one processor is further configured to provide a detection probability signal, and if the detection probability is less than a predefined threshold, the at least one processor is further configured to initiate a re-measurement for updating the LiDAR dataset of the environment.

Optionally, the re-measurement is implemented by using modified parameters.

### DETAILED DESCRIPTION OF THE DRAWINGS

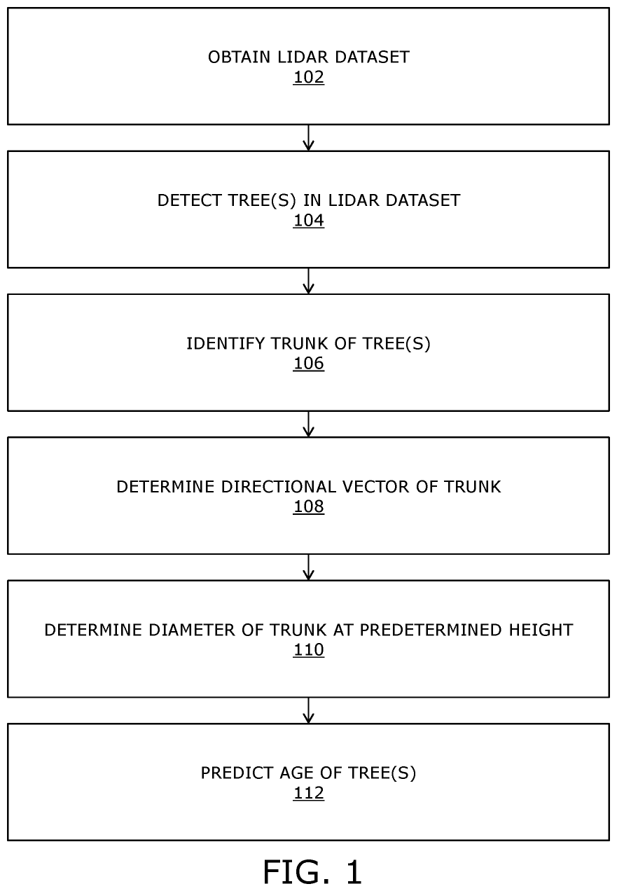

Referring to FIG. 1, illustrated are steps of a method for remotely analysing trees present in an environment, in accordance with an embodiment of the present disclosure. At step 102, a Light Detection and Ranging (LiDAR) dataset of the environment is obtained. At step 104, at least one tree represented in the LiDAR dataset is detected using a pre-trained graph neural network, wherein the at least one tree is assigned a unique identifier upon detection. At step 106, a trunk of the at least one tree is identified using at least one statistical technique. At step 108, a directional vector of the trunk of the at least one tree is determined using at least one linear fitting technique. At step 110, a diameter of the trunk of the at least one tree is determined at a predetermined height from a highest point of a ground surface surrounding the trunk, wherein the directional vector is employed for determining the diameter of the trunk. At step 112, an age of the at least one tree is predicted, based at least on the diameter of the trunk.

The aforementioned steps are only illustrative and other alternatives can also be provided where one or more steps are added, one or more steps are removed, or one or more steps are provided in a different sequence without departing from the scope of the claims herein.

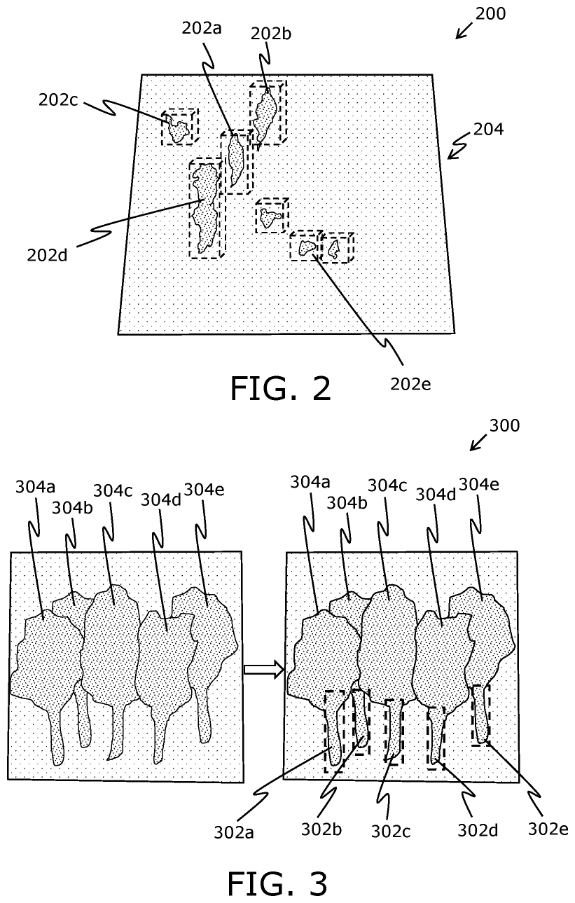

Referring to FIG. 2, illustrated is a step 200 of detection of at least one tree 202a, 202b, 202c, 202d, 202e (hereinafter collectively referred as 202) represented in the LiDAR dataset 204, in accordance with an embodiment of the present disclosure. Detection of the at least one tree 202 is performed using a pre-trained graph neural network. Moreover, the at least one tree 202 is assigned a unique identifier upon detection.

Referring to FIG. 3, illustrated is a step 300 of identification of a trunk 302a, 302b, 302c, 302d, 302e (hereinafter collectively referred as 302) of at least one tree 304a, 304b, 304c, 304d, 304e (hereinafter collectively referred as 304), in accordance with an embodiment of the present disclosure. Herein, the trunk 302 of the at least one tree 304 is identified using at least one statistical technique.

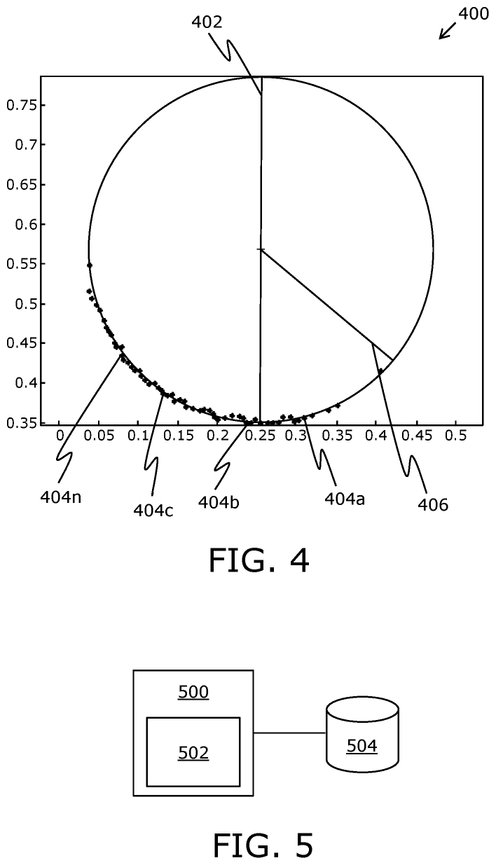

Referring to FIG. 4, illustrated is a step 400 of determination of a diameter 402 of a trunk of at least one tree, in accordance with an embodiment of the present disclosure. As shown, the diameter 402 of the trunk of the at least one tree is measured using a circle fitting technique. A plurality of LiDAR data points 404a, 404b, 404c, . . . 404n (hereinafter collectively referred as 404) are utilised to fit a smallest possible circle, and determine a radius 406. The radius 406 of the smallest possible circle is doubled to determine the diameter 402 of the trunk.

Referring to FIG. 5, illustrated is a schematic illustration of a system 500 for remotely analysing trees present in an environment, in accordance with an embodiment of the present disclosure. The system 500 comprises a processor 502. The system 500 is communicably coupled with a data repository 504. At least a Light Detection and Ranging (LiDAR) database is stored at the data repository 504.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for remotely analysing trees present in an environment, the method comprising:
obtaining a Light Detection and Ranging (LiDAR) dataset of the environment;
detecting at least one tree represented in the LiDAR dataset using a pre-trained graph neural network, wherein the at least one tree is assigned a unique identifier upon detection;
identifying a trunk of the at least one tree using at least one statistical technique;
determining a directional vector of the trunk of the at least one tree using at least one linear fitting technique;
determining a diameter of the trunk of the at least one tree at a predetermined height from a highest point of a ground surface surrounding the trunk, wherein the directional vector is employed for determining the diameter of the trunk; and
predicting an age of the at least one tree, based at least on the diameter of the trunk.

2. The method according to claim 1, wherein the method further comprises:
obtaining species information pertaining to the at least one tree, wherein the species information depends on at least one of: an average growth rate in the environment, hyperspectral data of the environment;
obtaining a location information of the at least one tree by at least one of: manual surveying of the environment, satellite surveying of the environment, receiving geolocation data from a geolocation device attached to the at least one tree, accessing from a memory having the location information;
determining a growth factor of the at least one tree, based on the species information and the location information; and
predicting the age of the at least one tree, based also on the growth factor.

3. The method according to claim 1, wherein the pre-training of the graph neural network is done by:
obtaining a reference LiDAR dataset of the environment;
dividing the reference LiDAR dataset into a plurality of tiles;
annotating a set of tiles from amongst the plurality of tiles to enable identification of at least one tree represented in the set of tiles; and
training the graph neural network using at least one machine learning algorithm, wherein the graph neural network is trained to identify the at least one tree.

4. The method according to claim 1, wherein the step of determining the diameter of the trunk comprises:
capturing LiDAR data points in a z-dimension at the predetermined height in a vicinity of the at least one tree, wherein the z-dimension is parallel to the directional vector of the trunk of the at least one tree;
performing a coordinate transformation of the LiDAR data points so that the LiDAR data points are indicated in a two-dimensional plane that is representative of a two-dimensional cross-section of the trunk;
determining a radius of the trunk using the two-dimensional cross-section by employing a circle fitting technique; and
calculating the diameter of the trunk by doubling the radius of the trunk.

5. The method according to claim 1, wherein the method further comprises:
obtaining information pertaining to a power distribution infrastructure in the environment;
determining, based on the LiDAR dataset, vegetation data of the at least one tree, wherein the vegetation data comprises a height of the at least one tree and a location of the at least one tree within the environment;
determining whether or not a given tree is a risky tree by assessing a risk posed by the given tree, wherein the risk is assessed based at least on: the information pertaining to the power distribution infrastructure, an age of the given tree, the vegetation data; and
generating an alert for removal of the given tree, when the given tree is determined to be a risky tree.

6. The method according to claim 5, further comprising:
obtaining species information pertaining to the at least one tree, wherein the species information depends on at least one of: an average growth rate in the environment, hyperspectral data of the environment;
generating a predictive growth model for the at least one tree, based on at least: the species information of the at least one tree, the age of the at least one tree; and
estimating, based on the predictive growth model, vegetation data and information pertaining to the power distribution infrastructure in the environment, a future time instant at which the given tree would become a risky tree, when the given tree is not determined to be a risky tree.

7. The method according to claim 5, further comprising creating an order of priority for removal of one or more trees that are determined to be risky trees, based on the assessment of risk posed by the one or more trees, wherein one or more alerts are generated for removal of the one or more trees based on the order of priority.

8. A method according to claim 1, wherein the pre-trained graph neural network is further used to provide a detection probability signal, and if the detection probability is less than a predefined threshold, the method further comprises initiating a re-measurement for updating the LiDAR dataset of the environment.

9. A method according to claim 8, wherein the re-measurement is implemented by using modified parameters.

10. A system for remotely analysing trees in an environment, the system comprising at least one processor, wherein the at least one processor is configured to:
obtain a Light Detection and Ranging (LiDAR) dataset of the environment;
detect at least one tree represented in the LiDAR dataset using a pre-trained graph neural network, wherein the at least one tree is assigned a unique identifier upon detection;
identify a trunk of the at least one tree using at least one statistical technique;
determine a directional vector of the trunk of the at least one tree using at least one linear fitting technique;
determine a diameter of the trunk of the at least one tree at a predetermined height from a highest point of a ground surface surrounding the trunk, wherein the directional vector is employed for determining the diameter of the trunk; and
predict an age of the at least one tree, based at least on the diameter of the trunk.

11. The system according to claim 10, wherein the at least one processor is further configured to:
obtain species information pertaining to the at least one tree, wherein the species information depends on at least one of: an average growth rate in the environment, hyperspectral data of the environment;
obtain location information of the at least one tree by at least one of: manual surveying of the environment, satellite surveying of the environment, receiving geolocation data from a geolocation device attached to the at least one tree, accessing from a memory having the location information;
determine a growth factor of the at least one tree, based on the species information and the location information; and
predict the age of the at least one tree, based also on the growth factor.

12. The system according to claim 10, wherein the at least one processor is further configured to train the graph neural network, wherein when training the graph neural network, the at least processor is configured to:
obtain a reference LiDAR dataset of the environment;
divide the reference LiDAR dataset into a plurality of tiles;
annotate a set of tiles from amongst the plurality of tiles to enable identification of at least one tree represented in the set of tiles; and
train the graph neural network using at least one machine learning algorithm, wherein the graph neural network is trained to identify the at least one tree.

13. The system according to claim 10, wherein when determining the diameter of the trunk, the at least one processor is further configured to:
capture LiDAR data points in a z-dimension at the predetermined height in a vicinity of the at least one tree, wherein the z-dimension is parallel to the directional vector of the trunk of the at least one tree;
perform a coordinate transformation of the LiDAR data points so that the LiDAR data points are indicated in a two-dimensional plane that is representative of a two-dimensional cross-section of the trunk;
determine a radius of the trunk using the two-dimensional cross-section by employing a circle fitting technique; and
calculate the diameter of the trunk by doubling the radius of the trunk.

14. The system according to claim 10, wherein the at least one processor is further configured to:
obtain information pertaining to a power distribution infrastructure in the environment;
determine, based on the LiDAR dataset, vegetation data of the at least one tree, wherein the vegetation data comprises a height of the at least one tree and a location of the at least one tree within the environment;
determine whether or not a given tree is a risky tree by assessing a risk posed by the given tree, wherein the risk is assessed based at least on: the information pertaining to the power distribution infrastructure, an age of the given tree, the vegetation data; and
generate an alert for removal of the given tree, when the given tree is determined to be a risky tree.

15. The system according to claim 14, wherein the at least one processor is further configured to:
obtain species information pertaining to the at least one tree, wherein the species information depends on at least one of: an average growth rate in the environment, hyperspectral data of the environment;
generate a predictive growth model for the at least one tree, based on at least: the species information of the at least one tree, the age of the at least one tree; and
estimate, based on the predictive growth model, vegetation data and information pertaining to the power distribution infrastructure in the environment, a future time instant at which the given tree would become a risky tree, when the given tree is not determined to be a risky tree.

16. The system according to claim 14, wherein the at least one processor is further configured to create an order of priority for removal of one or more trees that are determined to be risky trees, based on the assessment of risk posed by the one or more trees, wherein one or more alerts are generated for removal of the one or more trees based on the order of priority.

17. The system according to claim 10, wherein the at least one processor is further configured to provide a detection probability signal, and if the detection probability is less than a predefined threshold, the at least one processor is further configured to initiate a re-measurement for updating the LiDAR dataset of the environment.

18. The system according to claim 17, wherein the re-measurement is implemented by using modified parameters.
